(19) United States
(12) Patent Application Publication
(10) Pub. No.: US 2011/0213730 A1
(43) Pub. Date: Sep. 1, 2011

(54) GOAL PROGRAMMING APPROACH FOR OPTIMAL BUDGET ALLOCATION FOR NATIONAL ANALYSIS OF WILDLAND FIRE MANAGEMENT

(75) Inventors: Steven M. Carty, Loveland, CO (US); Tarun Kumar, Mohegan Lake, NY (US); Yan Liu, Elmsford, NY (US); Gyana R. Parija, Gurgaon (IN)

(73) Assignee: INTERNATIONAL BUSINESS MACHINES CORPORATION, Armonk, NY (US)

(21) Appl. No.: 12/714,935

(22) Filed: Mar. 1, 2010

(51) Int. Cl. G06Q 10/00

(52) U.S. Cl. 705/348

(57) ABSTRACT

A method for allocating resources in a business model includes determining a plurality of goals for a specified business problem. A plurality of data parameters are extracted from the goals into a computer program and read by a computer. The data parameters represent each of the goals. The data parameters are analyzed to develop a problem set representing the data parameters. Target criteria are input into the computer program, and the target criteria relates to each of the goals and may include prioritizing and/or attributing a weight to each goal. A solution instruction set is developed using the target criteria and the problem set. A solution model is developed from the solution instruction set. The steps of inputting target criteria, developing the solution instruction set, and developing the solution model are repeated to develop additional solution models and an optimal solution model can ultimately be selected.

### BACKGROUND

The present invention relates to a method for allocating resources in a business model having a plurality of goals, and more specifically, the method includes extracting and compressing data from the plurality of goals to generate a solution model.

Typically in business models there are multiple business problems and there is a need to optimize the business model across multiple business objectives. However, when multiple objectives are present, there is a need to find a robust solution which allows for competing objectives. If the objectives are aligned or non-conflicting, then the business problem reduces to solving a simple linear optimization problem. In business problems, researchers are faced with the challenge of solving problems with more than one objective which are not aligned or the objectives are conflicting. For example, a typical investment problem with two objectives is to maximize profit and minimize risk. Treating the problem using a single objective will lead to poor solutions. One commonly used approach is to cast one of the goals as objective and the rest as constraints. In doing so, the problem reduces to solving a standard single objective optimization problem. Bayesian Networks have also been used to study such problems. Using a Bayesian Network, a comparative analysis is done using either best policy or evaluating multiple policies using the conditional probability distribution. Further, a utility metric is computed using the conditional probability and the objective is then to maximize the utility and select the solution resulting in maximum utility value. Another approach is to use one of the Preemptive or Non-preemptive approaches. In the preemptive approach, the goals are ordered in decreasing importance and a linear optimization problem is framed with the first goal as the objective. The solution to the first iteration is applied to the next iteration where the objective is to second goal and so on. In non-preemptive approach, weights are assigned to each goal and the objective function is to minimize the weighted sum of deviation from the goals.

Each of the above three approaches above suffers from drawbacks. The first approach, wherein one of the goals is an objective and the rest are constraints, results in a sub-optimal solution since the solution space is constrained due to some of the goals being cast as hard constraints. The Bayesian Network approach is more qualitative than quantitative and does not provide “the optimal” solution. Using only the preemptive approach implicitly gives the higher priority goal infinitely more importance than the lower prioritize goal. On the other hand, using non-preemptive approach the choice of weights can have a dramatic impact on the solution. Changing the weights even slightly can have drastic changes in the optimal solution.

Therefore, it would be desirable to provide a method for solving business problems with multiple conflicting objectives. It would further be desirable for the method to provide a solution model using minimal data.

### BRIEF SUMMARY

In an aspect of the invention, a method for allocating resources in a business model includes: determining a plurality of goals for a specified business problem; extracting a plurality of data parameters from the goals into a computer program embodied in a computer readable medium read by a computer, the data parameters representing each of the goals; analyzing the data parameters representing each of the plurality of goals to develop a problem set representing the data parameters; inputting target criteria into the computer program, the target criteria relating to each of the goals; developing a solution instruction set using the target criteria and the problem set; developing a solution model from the solution instruction set; repeating the steps of inputting target criteria, developing the solution instruction set, and developing the solution model to develop additional solution models; and selecting an optimal solution model.

In a related aspect, the target criteria may include assigning a priority to each goal. In another aspect, the target criteria includes assigning a weight of importance to each goal. Further, the target criteria may include assigning a priority and a weight of importance to each goal. The data parameters may include cost limits and time constraints. Analyzing the data parameters may include using a regression analysis.

In another aspect of the invention a computer program product comprises a computer readable medium having recorded thereon a computer program for enabling a processor in a computer system for allocating resources in a business model. The computer program performs the steps of: determining a plurality of goals for a specified business problem; inputting a plurality of data parameters into a computer program embodied in a computer readable medium read by a computer, the data parameters representing each of the goals; analyzing the data parameters representing each of the plurality of goals to develop a problem set representing the data parameters; inputting target criteria into the computer program, the target criteria relating to each of the goals; developing a solution instruction set using the target criteria and the problem set; developing a solution model from the solution instruction set; repeating the steps of inputting target criteria, developing the solution instruction set, and developing the solution model to develop additional solution models; and selecting an optimal solution model.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings, in which:

FIG. 1 is a block diagram according to an embodiment of the invention depicting a method for allocating resources in a business model;

FIG. 2 is a block diagram of a computer, and data input into the computer and output data from the computer;

FIG. 3 is a block diagram of regression system depicting an effectiveness-efficiency performance (EEP) distribution, regression model, and distribution function; and

FIG. 4 is a block diagram of a hybrid goal programming approach including effectiveness-efficiency performance (EEPs) parameters, preemptive settings including EEP weights, EEP goals, and EEP penalties, and non preemptive setting, priority ordering of EEPs, which result in a national budget.

### DETAILED DESCRIPTION

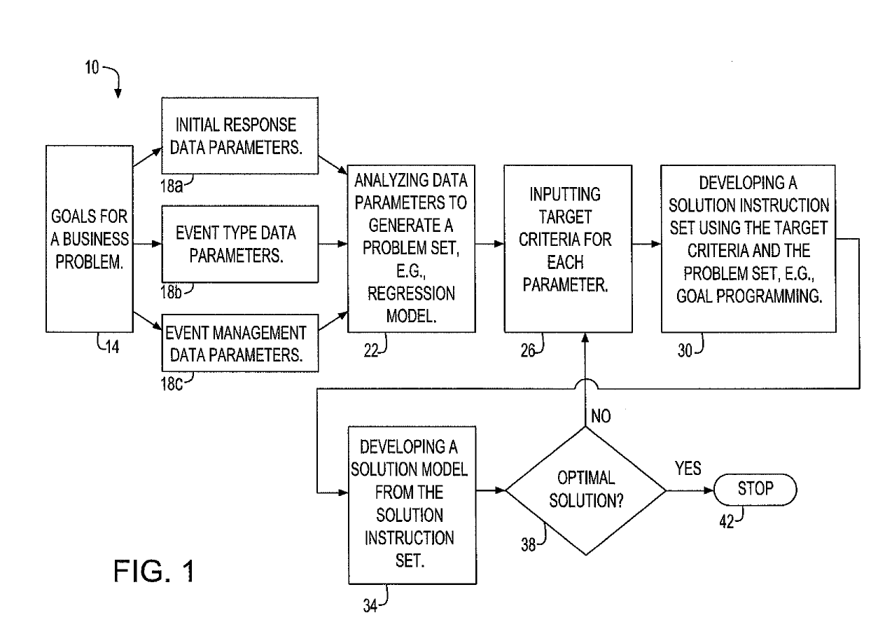

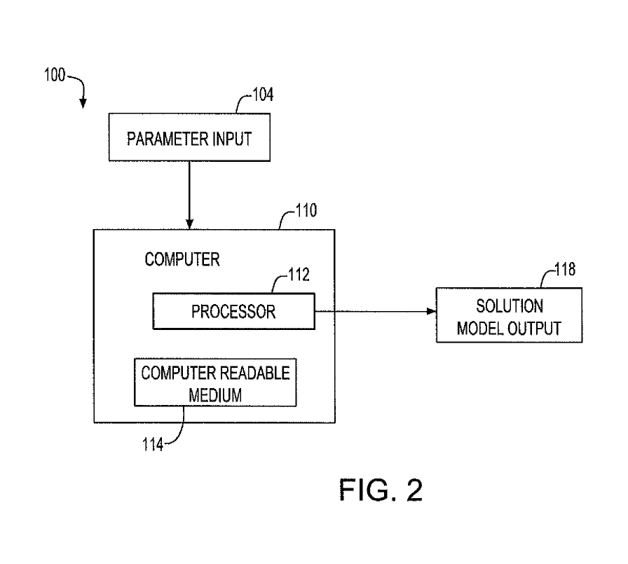

Referring to FIG. 1, an illustrative embodiment according to the present invention of a method for allocating resources in a business model is shown. The method 10 includes determining a plurality of goals or policies for a specified business problem, in step 14. In one embodiment of the invention, an optimal budget allocation for a national analysis of wildland fire management is desired. The goals may include reducing the risks of large fires and high intensity fires, maximizing the initial attack success rate on the fire, minimizing the wild land at risk, and the urban land at risk. Since some of these goals are conflicting or in opposition to one another, prioritization and/or a valuation of each goal may be applied as discussed below. A plurality of data parameters, exemplified by initial response data parameters 18a, event type data parameters 18b, and event management data parameters 18c encapsulate the goals in step 14 and are automatically extracted from the goal data in step 14 into a computer program stored on computer readable medium 114 read by a processor 112 in the computer 110, shown in FIG. 2. The system 100 shown in FIG. 2 depicts the inputting of data 104 into the computer program on the computer 110, and a solution model output 118.

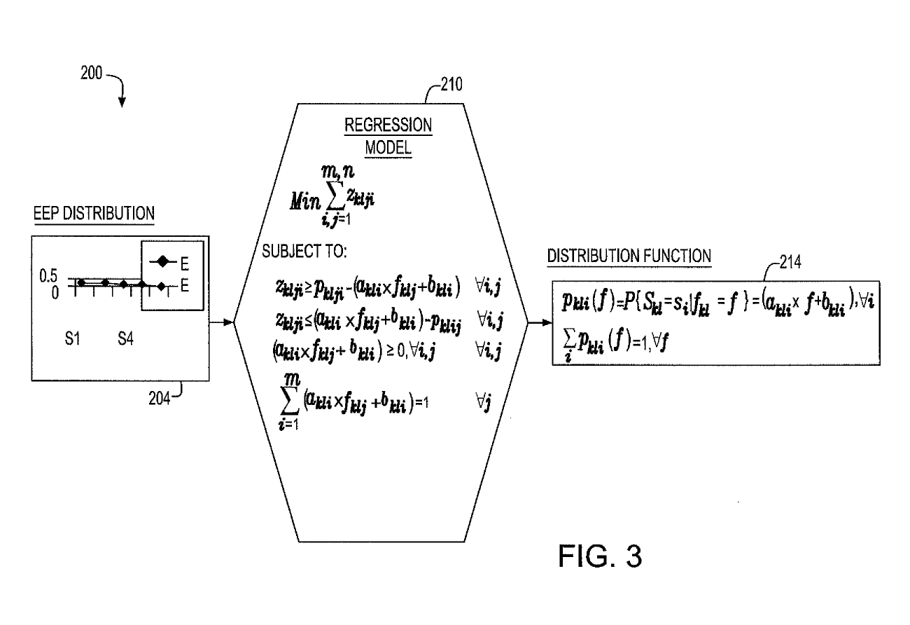

Referring to FIG. 1, the data parameters 18a-18c represent conditional discrete probability distributions of the goal data of step 14, e.g., representing the underlying data distribution of the goal data. Alternatively, the data parameters 18a-18c may be inputted into the computer program. The data parameters 18a-18c may include cost limits and time constraints for particular goals. The data parameters 18a-18c are analyzed by the computer program, for example using a regression model, in step 22, to develop a problem set representing the data parameters. A functional form may be used to build a compact representation of the goals and data parameters. For example, a regression model, as shown in FIG. 3, is used to obtain a distribution function using the data parameters which represent the goals. Further, Bayesian networks may also be used in a comparative analysis of goal policies. Additionally, one of the goals may be defined as an objective and the rest as constraints, or in other variations of objectives and constraints. Thus, the step of analyzing data parameters reduces the input data for developing a solution instruction set.

In step 26, target criteria is inputted into the computer program relating to each of the goals. The target criteria may include prioritizing the data parameters and/or assigning a weight or percentage of importance to each parameter in the analysis. Using a prioritization scheme as the criteria ensures that a higher priority goal is given more importance than a lower priority goal. This enables absolute ranking of the goals in the solution model. A preemptive modeling approach utilizes the priority ordering scheme. Using weights for each goal allows for relative ranking of the goals. Weights assigned to each goal act as a multiplier to the goal's values and thereby change the weight of the goals. A non-preemptive modeling approach utilizes the weighting scheme. A solution instruction set is developed using the target criteria and the problem set in step 30. The solution instruction set, for example, is a set of equations for calculation on the computer. A solution model is developed from the solution instruction set in step 34. The solution model of step 34 is a readable allocation of resources for the user to evaluate. The steps of inputting target criteria, developing the solution instruction set, and developing the solution model may be repeated as indicated in step 38 to develop additional solution models. One of the solution models may be selected as an optimal solution model, after which the method is completed as in step 42.

One advantage of the present invention is the ability to provide a solution to a large amount of goal data. The present invention extracts the data parameters representing the underlying data distribution of the goal data, and thus, processes, e.g., using regression, a smaller data group than if all goal data were processed. Another advantage of the present invention is the ability for a user to input criteria for analysis providing flexibility in arriving at a solution, using, for example, prioritizing and/or weighting (e.g., a percentage value) target criteria.

In general, for example, a National Budget Allocation Problem for Wildland Fire Management, presents a business problem because of the multiplicity of goals of the several agencies. The five US national agencies are the Forest Services, National Park Services, Bureau of Land Management, Fish and Wildlife Services and the Bureau of Indian Affairs which state objectives derived from subject matter experts, such as the Wildland Fire Leadership Council (WFLC) to create an effectiveness-efficiency performance (EEP) metric. EEPs are a collection of objectives directed to the objectives of the various agencies. The objectives include reducing the probability of occurrence of costly fires; reducing the probability of occurrence of costly fires within the wild-land urban interface (WUI); protecting highly valued resources (HVR) areas from unwanted fires; increasing the proportion of land meeting or trending towards the attainment of fire and fuels management objectives; maintaining a high initial attack success rate; maintaining the total budget allocated for the initial response; and maintaining the total budget allocated for the fuels management practice. The present invention provides a strategic budgeting tool which optimizes the national budget keeping all of the above objectives in consideration and delivering information on the status with respect to each EEP.

A regression system 200 is shown in FIG. 3. The objective of this system is to reduce the size of the problem data instance. Hence, rather than use the data itself, it is advantageous to extract the function representing the underling data distribution. As a simple example: if a linear function ax+b is assumed, then a regression model 210 will use the input discrete distribution data to return the optimal values of parameters “a” and “b”. The closed form expression ax+b represents the discrete distribution. FIG. 3 also shows an optimization approach of performing a linear regression. The closed form expression represents the underlining discrete distribution. This closed form expression is a very compact representation 214 of the underlining discrete input data. This transformation helps remove the dependency of creating decision variables corresponding to each state of a budget, e.g., the EEP-Budget level combination 204. The compact representation 214 is then used as input to the goal programming step 30 shown in FIG. 1. The closed form expression is also used as an input to the goal programming step 30 to enable users to specify both a priority ordering (preemptive mode) and weights (non-preemptive mode) of the goals. One approach is to combine the preemptive and non-preemptive approaches. Although the above example uses linear regression, piecewise linear approximation and spline approximation can be used as well.

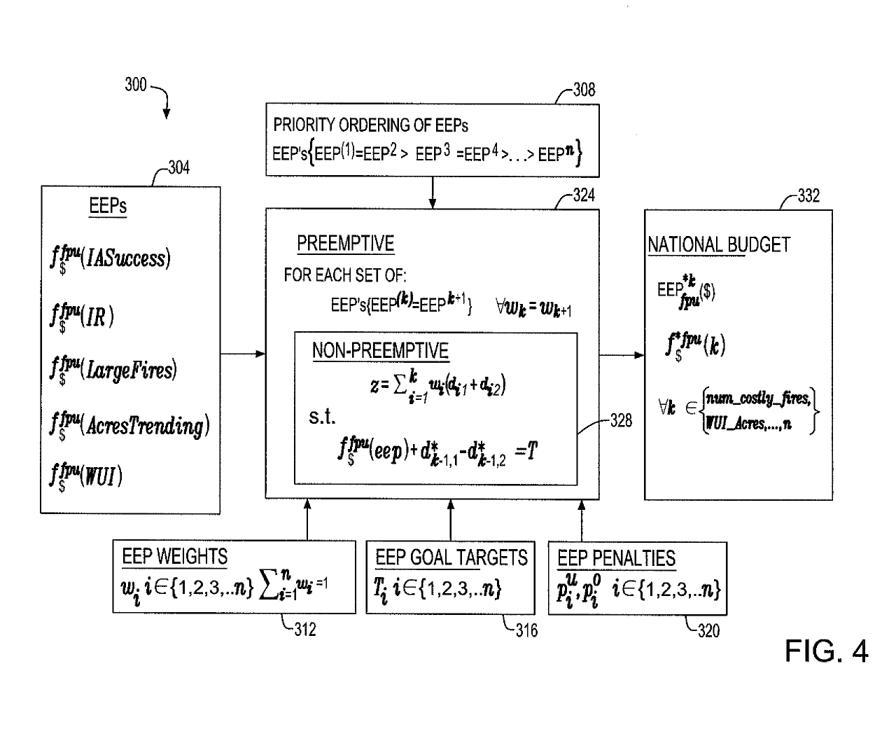

FIG. 4 depicts a hybrid goal programming approach 300. For a given priority ordering of EEPs 304, some EEPs are infinitely more important than other EEPs 308, while another subset of EEPs have equal priority ordering but are assigned different weights 312. Goal targets 316 specify the optimal expected goal achievement and are part of the input parameters. The solution model seeks to achieve the goal targets set for each of the goals. Penalties 320 help distinguish the relative importance in spite of equal weights. An underachievement penalty penalizes underachievement of the goal values to the goal target, while an overachievement penalty penalizes overachievement. The penalty values improve the sensitivity of the solution to underachieving and overachieving goal targets. This approach at two extreme EEP settings results in non-preemptive settings 328 at one extreme end, and preemptive settings 324 at the other extreme end.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the drawings illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

What is claimed is:

1. A method for allocating resources in a business model, comprising:
determining a plurality of goals for a specified business problem;
extracting a plurality of data parameters from the goals into a computer program embodied in a computer readable medium read by a computer, the data parameters representing each of the goals;
analyzing the data parameters representing each of the plurality of goals to develop a problem set representing the data parameters;
inputting target criteria into the computer program, the target criteria relating to each of the goals;
developing a solution instruction set using the target criteria and the problem set;
developing a solution model from the solution instruction set;
repeating the steps of inputting target criteria, developing the solution instruction set, and developing the solution model to develop additional solution models; and
selecting an optimal solution model.

2. The method of claim 1, wherein the target criteria includes assigning a priority to each goal.

3. The method of claim 1, wherein the target criteria includes assigning a weight of importance to each goal.

4. The method of claim 1, wherein the target criteria includes assigning a priority and a weight of importance to each goal.

5. The method of claim 1, wherein the data parameters include cost limits and time constraints.

6. The method of claim 1, wherein analyzing the data parameters includes using a regression analysis.

7. A computer program product comprising a computer readable medium having recorded thereon a computer program for enabling a processor in a computer system for allocating resources in a business model, the computer program performing the steps of:
determining a plurality of goals for a specified business problem;
inputting a plurality of data parameters into a computer program embodied in a computer readable medium read by a computer, the data parameters representing each of the goals;
analyzing the data parameters representing each of the plurality of goals to develop a problem set representing the data parameters;
inputting target criteria into the computer program, the target criteria relating to each of the goals;
developing a solution instruction set using the target criteria and the problem set;
developing a solution model from the solution instruction set;
repeating the steps of inputting target criteria, developing the solution instruction set, and developing the solution model to develop additional solution models; and
selecting an optimal solution model.

8. The method of claim 7, wherein the target criteria includes assigning a priority to each goal.

9. The method of claim 7, wherein the target criteria includes assigning a weight of importance to each goal.

10. The method of claim 7, wherein the target criteria includes assigning a priority and a weight of importance to each goal.

11. The method of claim 7, wherein the data parameters include cost limits and time constraints.

12. The method of claim 7, wherein analyzing the data parameters includes using a regression analysis.
